(19) United States
(12) Patent Application Publication
(10) Pub. No.: US 2009/0186166 A1
(43) Pub. Date: Jul. 23, 2009

(54) Method for Coating a Metallic Component

(76) Inventors: Josef Hirsch, Homburg (DE); Lutz Enzensperger, Schwieberdingen (DE); Dirk Zimmermann, Stuttgart (DE); Branko Alfermann, Bovenden (DE)

Correspondence Address: KENYON & KENYON LLP, ONE BROADWAY, NEW YORK, NY, 10004, US

(21) Appl. No.: 11/992,353

(22) PCT Filed: Sep. 12, 2006
(86) PCT No.: PCT/EP2006/066253

§ 371 Date: Mar. 11, 2009

(30) Foreign Application Priority Data
Sep. 29, 2005 (DE) 10 2005 046 628.1

(51) Int. Cl. B05D 7/14; B05D 3/00; B08B 3/12; F02M 61/16

(52) U.S. Cl. 427/560; 427/299

(57) ABSTRACT

A method is described for coating a surface of a metallic component of a valve device for controlling and regulating a fluid volume flow, in particular of an injector housing, using a corrosion protection layer, which is cleaned prior to the coating process and dried after the coating process. The corrosion protection layer is produced by wetting the surface using an aqueous solution containing monomeric silane derivatives, the monomers forming polymers during drying of the component subsequent to wetting.

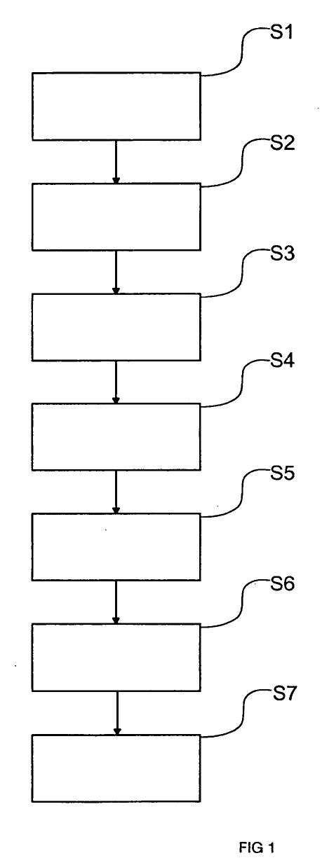

### FIELD OF THE INVENTION

The present invention relates to a method for coating the surface of a metallic component of a valve device for controlling and regulating a fluid volume flow, in particular of an injector housing, using a corrosion protection layer, which is cleaned prior to the coating process and dried after the coating process.

### BACKGROUND INFORMATION

Common rail injectors from practice, which are used, for example, in utility vehicles, include components made of regular steel such as 42CrMoS4, which are oxidized during storage under the atmospheric effect and exhibit undesirable rusting.

To avoid rusting, the components of the injectors, in particular the injector body, are pickled, after thermal deburring, during a so-called phosphatization to remove rust from the surface.

The disadvantage here is, however, that pickling of the injector components causes pitting, which occurs, for example, by the dissolution of so-called manganese sulfide stringers. This pitting results in impairment in the functionality in the interior of an injector, in which, during the operation of the injector, the fuel flows with great pressure fluctuations between a fuel supply line and injection openings, because cracks may occur in the area of the material reductions which may result in leaks between a high-pressure zone and a low-pressure zone of the injector system.

### SUMMARY OF THE INVENTION

An object of the exemplary embodiments and/or exemplary methods of the present invention is therefore to provide a method with the aid of which components of injectors, i.e., valve devices for controlling and regulating fluid volume flows, have a long service life and are cost-effectively manufacturable.

This object is achieved according to the exemplary embodiments and/or exemplary methods of the present invention by a method having the features described herein.

In the method according to the present invention for coating a metallic component of a valve device for controlling and regulating a fluid volume flow, in particular of an injector housing using a corrosion protection layer which is cleaned prior to the coating process and dried after the coating process, the corrosion protection layer is manufactured by wetting the surface with an aqueous solution containing monomeric silane derivatives, the monomers forming polymers during drying of the component that follows the wetting.

A corrosion protection layer manufactured in this way is applicable to the surface of a metallic component cost-effectively and without pickling scars and may be easily inserted into the existing manufacturing sequences. The silane derivatives may be siloxane derivatives which are linked to a what may be a polymerizable organic radical in the area of a valence electron. Furthermore, the central silicon atom also has OH groups in the area of the other three valence electrons.

Using the method according to the present invention, the reject rate of valve devices, i.e., common rail injectors, is reduced in a simple manner and product quality is improved because components, i.e., injector housings, are provided with a corrosion protection layer which is applicable without damaging the components.

Further advantages and advantageous embodiments of the subject matter of the present invention are presented in the description and the drawing.

A variant of the method according to the present invention is depicted in a schematically simplified manner in the drawing in the form of a block diagram and elucidated in greater detail in the description that follows.

### BRIEF DESCRIPTION OF THE DRAWING

The sole FIGURE of the drawing shows a highly simplified sequence diagram of the method according to the present invention.

### DETAILED DESCRIPTION

In a first step S1 depicted in the FIGURE, a component (not shown in detail), i.e., an injector housing of a common rail injector, is cleaned during a pre-cleaning step using an alkaline cleaner diluted with water at a temperature below 40° C., which may be at room temperature, in an immersion bath over a predefined time period of 10 s to 180 s, which may be 60 s. The alkaline cleaner contains surfactants and complexing agents, which represent a silicate-based cleaner structure and dissolve the fats and contaminants on the surface of the injector housing.

Subsequently, the component, i.e., the injector housing, is immersed into an immersion bath during a second step S2 subsequent to pre-cleaning step S1, the immersion bath being filled with a more concentrated alkaline cleaning bath containing the same surfactants and complexing agents as the alkaline cleaner of pre-cleaning step S1 and is characterized by a higher concentration than the cleaner used during pre-cleaning step S1. Second cleaning step S2 is performed at 70° C. to 85° C., which may be at 80° C., the component being additionally exposed to ultrasound at 30 W/l to 45 W/l, which may be 40 W/l for 10 s to 180 s, which may be 60 s.

The higher process temperature, the higher concentration of the alkaline cleaner, and the ultrasound treatment during second step S2 cause the surface contaminants of the component which were not removed during pre-cleaning step S1 to be removed from the surface of the injector housing due to the enhanced cleaning power.

Subsequently thereto, during a third step S3, the injector housing is exposed to ultrasound between 30 W/l to 45 W/l, which may be 40 W/l, in a water-filled rinsing cascade at a temperature between 15° C. and 40° C., which may be at room temperature, for 30 s to 180 s, which may be 60 s, and rinsed.

Subsequently thereto, during a fourth step S4, the component is rinsed using another rinsing cascade filled with water at a temperature between 15° C. and 40° C., which may be at room temperature, for 30 s to 180 s, which may be 60 s, before the component is immersed into an immersion basin for 20 s to 70 s, which may be 50 s to 60 s. The immersion basin is filled with an aqueous solution containing a silane derivative, which is held at a constant temperature of 20° C. to 45° C., which may be 35° C., as a function of the particular application, and permanently recirculated using a recirculating pump.

During the immersion process, monomeric silane derivatives are deposited on the metallic surface of the injector housing, which is manufactured, in this case, of 42CrMoS4 or 50CrMoS4, due to adhesive surface forces, so that, when it is removed from the immersion basin, the entire surface of the injector housing is covered with monomeric silane derivatives.

These monomeric silane derivatives have silicon as the central atom, which is connected to OH groups via three valence electrons and the fourth valence electron is connected to an organic, which may be polymerizable, radical.

After the elapse of the coating time of step S5, i.e., the immersion time of the injector housing, the injector housing is dried, in this case during an induction drying step S6, for between 5 s and 50 s, which may be 30 s, at an approximately constant 0.1 kW to 0.6 kW, the set power being strongly dependent on the geometry of the injector housing, i.e., the component, during induction drying. During induction drying step S6, the monomeric silane derivatives adhering to the surface of the injector housing cross-link, forming polymers, the water formed during cross-linking being evaporated without damaging the surface layer of the injector housing.

The process is conducted in such a way that the process temperature during drying step S6 is lower than 100° C. to prevent water from being splashed from the surface of the injector housing. Under some circumstances, the above-mentioned phenomenon results in damage to the polymerized silane layer representing a corrosion protection layer of the component.

The silane derivatives, which are monomeric before drying, on the surface layer of the injector housing cross-link with further silane derivatives both in the same layer and in adjacent layers thereunder or thereabove with respect to the surface of the injector housing, so that the cross-linking of the monomeric silane derivative forms a three-dimensional polymer layer which adheres well to the surface of the injector housing and reliably shields the surface against environmental influences.

In order to improve the handling of the dried injector housing, a cooling step S7, during which the component temperature of the injector housing which has now been provided with a finished coating is lowered to approximately 40° C., is provided after drying step S6. At such a component temperature, a visual inspection following silanization of the injector housing and handling of the part by an inspector may be performed in a simple manner.

The injector housing heated by drying may be cooled, for example, using commercially available standard cooling in an air-flow cooling tunnel within three to five minutes from a component temperature of 100° C. to less than 40° C.

The cooling time may be reduced to less than 60 s if the injector housing is immersed into cold water immediately after drying and polymerization of the silane derivatives which occurs during drying. In such a procedure, the component temperature of the injector housing is reduced within approximately 10 s to less than 50° C. and the component is cooled by a further 20° C. and dried at the same time during subsequent vacuum drying.

The above-described induction drying during induction drying step S6 is suitable in particular for a so-called single-part or small-lot treatment, while in the case of larger lots, so-called condenser dryers, in which the components are exposed to dried air, represent suitable alternatives.

The above-described method according to the present invention represents a particularly effective option for manufacturing corrosion-resistant components for valve devices for controlling and regulating a fluid volume stream or for common-rail injectors, which are exposed to corrosive environmental influences both during storage and in the installed state.

The coating method according to the present invention, which is considerably less damaging to the component and avoids pitting and the like, than are phosphate-based pickling processes, results in a reduction in the reject rate and thus in an increase in the service life of common-rail injectors, with the help of which fuel is injected into the combustion chamber of the drive unit with ever-increasing pressures to reduce consumption of diesel engines.

1-10. (canceled)

11. A method for coating a surface of a metallic component of a valve device for controlling and regulating a fluid volume flow, in particular of an injector housing, using a corrosion protection layer, which is cleaned prior to the coating process and dried after the coating process, wherein the corrosion protection layer is produced by wetting the surface using an aqueous solution containing monomeric silane derivatives, the monomers forming polymers during drying of the component subsequent to wetting.

12. The method of claim 11, wherein a surface of the component is cleaned using an alkaline cleaning bath, which contains surfactants and complexing agents, during a cleaning step at 70° C. to 85° C.

13. The method of claim 12, wherein, during the cleaning, the component is additionally exposed to ultrasound with 30 W/l to 45 W/l.

14. The method of claim 12, wherein the cleaning lasts 10 s to 180 s.

15. The method of claim 12, wherein a pre-cleaning, using an alkaline cleaner diluted with water compared with the alkaline cleaner used in the cleaning step, at a temperature below 40° C. precedes the cleaning.

16. The method of claim 12, wherein, after the cleaning, the component is exposed to ultrasound between 30 W/l to 45 W/l for 30 s to 180 s in a water-filled rinsing cascade at a temperature between 15° C. and 40° C., and rinsed.

17. The method of claim 16, wherein, after the rinsing, the component is rinsed in water in a further rinsing cascade at a temperature between 15° C. and 40° C. for 30 s to 180 s.

18. The method of claim 11, wherein the surface of the component is wetted for 20 s to 70 s in an immersion basin containing the silane derivatives at 20° C. to 45° C.

19. The method of claim 18, wherein the component, after wetting with the silane derivatives, is dried for 5 s to 50 s at 0.1 kW to 0.6 kW during an induction drying, and the monomeric silane derivatives form polymers, the drying temperature being held below 100° C. as long as at least approximately all the water has evaporated from the surface layer of the component containing silanes.

20. The method of claim 19, wherein the component is cooled to a temperature below 40° C. after drying.

21. The method of claim 11, wherein a surface of the component is cleaned using an alkaline cleaning bath, which contains surfactants and complexing agents, during a cleaning step at 80° C.

22. The method of claim 12, wherein, during the cleaning, the component is additionally exposed to ultrasound with 40 W/l.

23. The method of claim 12, wherein the cleaning lasts 60 s.

24. The method of claim 12, wherein a pre-cleaning, using an alkaline cleaner diluted with water compared with the alkaline cleaner used in the cleaning, at room temperature, precedes the cleaning.

25. The method of claim 12, wherein, after the cleaning, the component is exposed to ultrasound at 40 W/l for 60 s, in a water-filled rinsing cascade at room temperature, and rinsed.

26. The method of claim 25, wherein, after the rinsing, the component is rinsed in water in a further rinsing cascade at a temperature at room temperature for 60 s.

27. The method of claim 11, wherein the surface of the component is wetted for 20 s to 70 s, which may be 50 s to 60 s, in an immersion basin containing the silane derivatives, at 35° C.
